(19) United States
(12) Patent Application Publication
(10) Pub. No.: US 2025/0307378 A1
(43) Pub. Date: Oct. 2, 2025

(54) Web Page Password Capture and Evaluation

(71) Applicant: SECURITY SAVVY LTD., Ramat Gan (IL)

(72) Inventors: Eldar Kleiner, Tel Aviv (IL); David Ben Zakai, Ramat Gan (IL); Daniel Parolla, Rosh-HaAyin (IL); Timor Eizenman, Tel Aviv-Yafo (IL); Yoav Horman, Tel-Aviv (IL); Guy Guzner, Tel Aviv (IL)

(21) Appl. No.: 18/617,706

(22) Filed: Mar. 27, 2024

(51) Int. Cl. G06F 21/46

(52) U.S. Cl. CPC G06F 21/46

(57) ABSTRACT

Methods, storage systems and computer program products implement embodiments of the present invention method for protecting a client computer, which includes a processor and a display. The method includes analyzing a web page that was downloaded to the client computer, and identifying, by the processor, a password input field in the web page. After rendering the password input field to the display, an input to the password input field is captured, and the captured input is evaluated against a specified password policy. Finally, an alert is generated upon detecting a violation of the specified password policy.

### FIELD OF THE INVENTION

The present invention relates generally to computer security, and specifically to enforcing policies for web page passwords.

### BACKGROUND OF THE INVENTION

Password policies are essential for ensuring the security of digital systems and safeguarding sensitive information. Serving as a fundamental component of cybersecurity strategies, these policies play a crucial role in user authentication. By enforcing strong password requirements, organizations can prevent unauthorized access to systems and protect against data breaches. Password policies contribute to network security, compliance with regulatory standards, and the establishment of user accountability. They can also help mitigate the risk of credential stuffing attacks, reduce insider threats, and promote a security-conscious culture within organizations. Overall, password policies are instrumental in maintaining the integrity and confidentiality of digital assets in today's interconnected and data-driven environment.

The description above is presented as a general overview of related art in this field and should not be construed as an admission that any of the information it contains constitutes prior art against the present patent application.

### SUMMARY OF THE INVENTION

There is provided, in accordance with an embodiment of the present invention, a method for protecting a client computer, which includes a processor and a display, the method including analyzing a web page that was downloaded to the client computer, identifying, by the processor, a password input field in the web page, capturing, after rendering the password input field to the display, an input to the password input field, evaluating the captured input against a specified password policy, and generating an alert upon detecting a violation of the specified password policy.

In one embodiment, the steps of analyzing, identifying, capturing, evaluating and generating are performed by a browser extension for a web browser configured to download the web page, and to render the password input field.

In another embodiment, the web page includes browser executable code, and wherein identifying the password input field includes identifying the password input field in the browser executable code.

In an additional embodiment, the web page includes browser executable code, and the method further includes generating document object model (DOM) elements in response to executing the browser executable code, and wherein identifying the password input field includes identifying the password input field in one or more of the DOM elements.

In a further embodiment, the captured input includes a captured password.

In a supplemental embodiment, evaluating the captured input against the specified password policy includes searching for a specified substring in the captured password, and wherein detecting the violation includes the specified substring in the captured password.

In one embodiment, evaluating the captured input against the specified password policy includes classifying, using a set of criteria, the captured password as either weak or strong, and wherein detecting the violation includes classifying the captured password as weak.

In some embodiments, the method further includes rendering a user identifier (ID) input field on the display, capturing an additional input to the user ID field, wherein the captured additional input includes a captured user ID, and wherein evaluating the captured input includes conveying, to the password server, a tuple including the captured user ID and the captured password.

In other embodiments, conveying the captured password to the password server includes applying a hash function to the captured password, and conveying the result of the hash function to the password server.

In additional embodiments, evaluating the captured input against the specified password policy includes encrypting the result of the hash function, and conveying the encrypted result of the hash function to the password server.

In further embodiments, detecting the violation of the specified password policy includes receiving an indication from the password server that the conveyed tuple includes a compromised password.

In supplemental embodiments, detecting the violation of the specified password policy includes receiving an indication from the password server that the conveyed tuple includes a duplicate password for a user referenced by the user ID.

There is also provided, in accordance with an embodiment of the present invention, a client computer, including a display, and one or more processors configured to analyze a web page that was downloaded to the client computer, to identify a password input field in the web page, to capture, after rendering the password input field to the display, an input to the password input field, to evaluate the captured input against a specified password policy, and to generate an alert upon detecting a violation of the specified password policy.

There is additionally provided, in accordance with an embodiment of the present invention, a computer software product for protecting a client computer, which includes a display, the computer software product including a non-transitory computer-readable medium, in which program instructions are stored, which instructions, when read by a computer, cause the client computer to analyze a web page that was downloaded to the client computer, to identify a password input field in the web page, to capture, after rendering the password input field to the display, an input to the password input field, to evaluate the captured input against a specified password policy, and to generate an alert upon detecting a violation of the specified password policy.

### BRIEF DESCRIPTION OF THE DRAWINGS

The disclosure is herein described, by way of example only, with reference to the accompanying drawings, wherein:

FIG. 1 is a block diagram that schematically shows a computing facility comprising a client computer configured to communicate with a web server and a password server, in accordance with an embodiment of the present invention;

FIG. 2 is a block diagram that schematically shows hardware and software components of the client computer, in accordance with an embodiment of the present invention; and

FIG. 3 is a flow diagram that schematically illustrates a method of capturing a password input to a web page, and evaluating the captured password against one or more password policies, in accordance with an embodiment of the present invention.

### DETAILED DESCRIPTION OF EMBODIMENTS

Enforcing password policies with external servers is a critical aspect of maintaining a secure digital environment. Whether dealing with cloud services, third-party platforms, or other external servers, implementing robust password policies helps protect sensitive data and prevent unauthorized access.

While organizations can control password policies for its computer resources (e.g., client and server computer systems), the organization may not be able to enforce these password policies on services provided by servers external to the organizations (e.g., web-based email providers). Embodiments of the present invention provide methods and systems for enforcing password policies for external web-based services.

As described hereinbelow, a web page is downloaded to a client computer, and a password input field is identified in the web page. Upon rendering the password input field to the display and capturing an input to the password input field, the client computer can evaluate the captured input against a specified password policy. Finally, an alert is generated upon detecting a violation of the specified password policy.

By capturing and evaluating passwords inputs, client computers implementing embodiments of the present invention can enforce organization password policies when members of the organization access web pages that provide services not managed by the organization.

### System Description

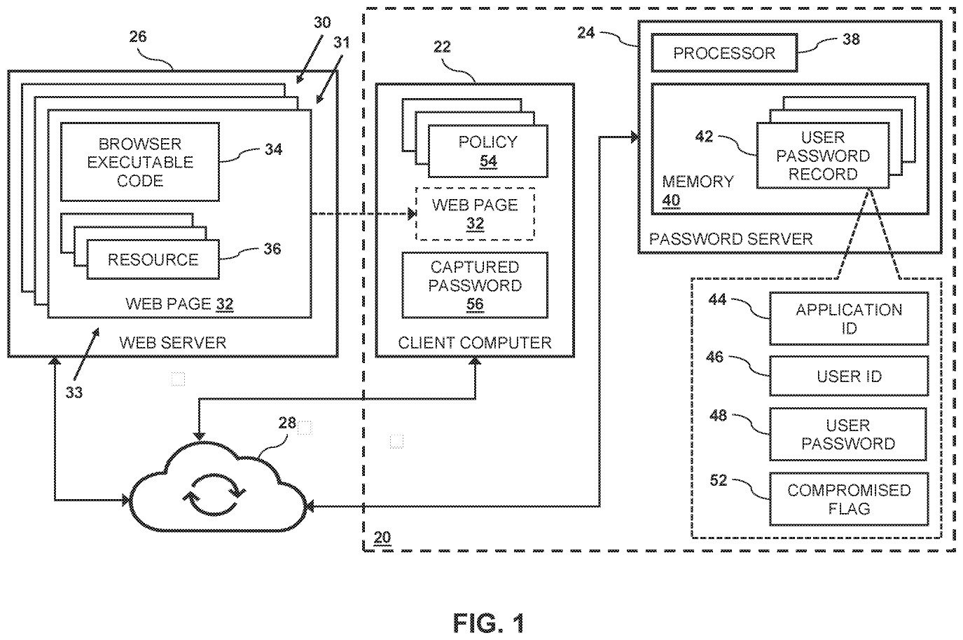

FIG. 1 is a block diagram that shows an example of a computing facility 20 comprising a client computer 22 and a password analysis server 24, in accordance with an embodiment of the present invention. In the configuration shown in FIG. 1, client computer 22 can communicate with passwords server 24 and a web server 26 over a data network 28 such as the Internet. In embodiments herein, data network 28 may also be referred to as Internet 28.

Web server 26 can host a web service 30 comprising a set of one or more web pages 32, each of the web pages comprising browser executable code 34 and a set of web page resources 36. Examples of a web service 30 include but are not limited to a website and a web-based application. Therefore, web service 30 may also be referred to as website 30 or web-based application 30.

Web service 30 can have a corresponding web-based application ID 31 and a corresponding category 33. In one embodiment category 33 can indicate a type of service (e.g., a banking service or an email service) provided by web service 30. In some embodiments, the type of service can indicate whether or not web service 30 provides a service for personal (e.g., a personal email service) or professional (e.g., a corporate email service) use.

Examples of browser executable code 34 include, but are not limited to, HyperText Markup Language (HTML) code, Javascript code, and Cascading Style Sheet (CSS) code. Examples of web page resources 36 include, but are not limited to, fonts, images, icons, audio files and video files.

Password server 24 may comprise a server processor 38 and a server memory 40 that can store a set of user password records 42. Each user password record 42 can store information such as:
An application identifier (ID) 44 referencing a given web service 30.
A user ID 46 that can be used to access the given web service. User ID 46 typically comprises a text string (e.g., an email address) referencing a given user of the given web service.
A user password 48 comprising a text string, that when input with the user ID, can authenticate the given user in order to access web service 30. In a first password embodiment, password server 24 can store user password 48 as a hashed value (i.e., the result of a hash function applied to a cleartext password). In a second password embodiment, password server 24 can store user passwords 48 as an encrypted hash value (i.e., the result of encrypting the hash function applied to a cleartext password). These password embodiments can help protect password server 24 in the event of a dictionary attack.
A compromised flag 52 that processor 38 can set upon detecting that the combination of user ID 46 and user password 48 has been (i.e., has been reported as being) compromised.

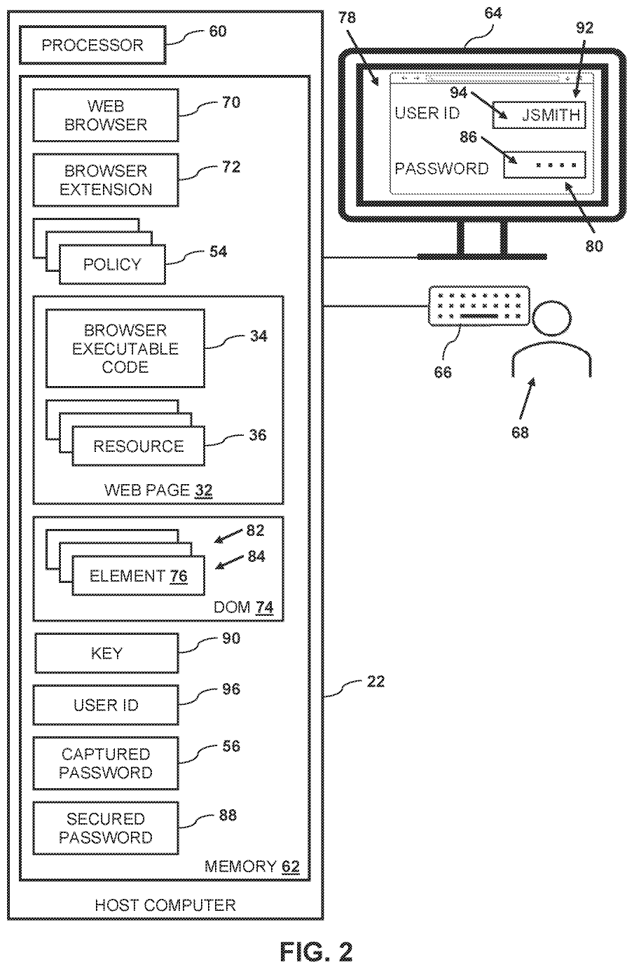

As shown in FIG. 1, client computer 22 is configured to receive a given web page 32 from web server 26, and the client computer comprises a set of password policies 54 and a captured password 56. In embodiments described herein, upon capturing password 56, client computer 22 can analyze the captured password to ensure that it complies with password policies 54. Examples of password policies 54 are described hereinbelow. Additional details of client computer 22 are described in the description referencing FIG. 2 hereinbelow.

FIG. 2 is a block diagram showing an example of a configuration of client computer 22, in accordance with an embodiment of the present invention. In the configuration shown in FIG. 2, client computer 22 comprises a client processor 60, a client memory 62, a display 64, and an input device such as a keyboard 66 that can be operated by a user 68.

Memory 62 comprises web page 32, a web browser 70 (e.g., CHROME™ produced by ALPHABET INC., 1600 Amphitheatre Parkway, Mountain View, CA 94043, USA) and a browser extension 72 (also known as a browser plugin) comprising a software module that enables the web browser to perform embodiments described herein. Upon receiving web page 32, web browser 70 (executing on processor 60) can execute browser executable code 34 with resources 36 so as to generate a domain object model (DOM) 74 comprising DOM elements 76 that the web browser can use to present a rendering 78 on display 64.

In embodiments herein, browser extension 72 is configured to identify a password input field 80 in web page 32. In these embodiments, browser extension 72 can identify one or more DOM elements 76 in web page 32 that web browser 70 can use to present password input field 80 in rendering 78. For example, the detected DOM elements may comprise a password tag 82 in a form tag 84. The following is an example of HTML code 34 comprising a given password input field 80 that browser extension 72 can identify in embodiments of the present invention:
input type=“password”
autocomplete=“password”
id=“680945e370bd6”
name=“password”
data-uia=“password-field” data-autofill=“true”>

In these embodiments, upon user 68 using keyboard 66 to enter a password 86 in password input field 80, browser extension 72 can capture and store the entered password to captured password 56.

In some embodiments, processor 60 can apply a hash function to captured password 56 so as to generate a hashed value, and store the hashed value to a secured password 88 in memory 62. In additional embodiments, memory 62 may comprise an encryption key 90, and processor 60 can use the encryption key to encrypt captured password 56 or the hashed value in secured password 88, and store the result of the encryption to secured password 88.

Using embodiments similar to identifying password input field 80 and capturing password 86, browser extension 72 can also be configured to detect a user ID input field 92 in web page 32. Upon web browser 70 presenting user ID input field 92 in rendering 78, and user 68 using keyboard 66 to enter a user ID 94 in the user ID input field, browser extension 72 can capture the input (i.e., the entered user ID), and store the entered user ID to captured user ID 96 in memory 62.

Processors 38 and 60 comprise general-purpose central processing units (CPU) or special-purpose embedded processors, which are programmed in software or firmware to carry out the functions described herein. This software may be downloaded to client computer 22 and password server 24 in electronic form, over a network, for example. Additionally or alternatively, the software may be stored on tangible, non-transitory computer-readable media, such as optical, magnetic, or electronic memory media. Further additionally or alternatively, at least some of the functions of processors 38 and 60 may be carried out by hard-wired or programmable digital logic circuits.

Examples of memories 40 and 62 include dynamic random-access memories, non-volatile random-access memories, hard disk drives and solid-state disk drives.

In some embodiments, tasks described herein performed by client computer 22, password server 24 and web server 26 may be split among multiple physical and/or virtual computing devices such as physical and/or virtual servers. In other embodiments, these tasks may be performed by a managed cloud service.

### Password Capture and Verification

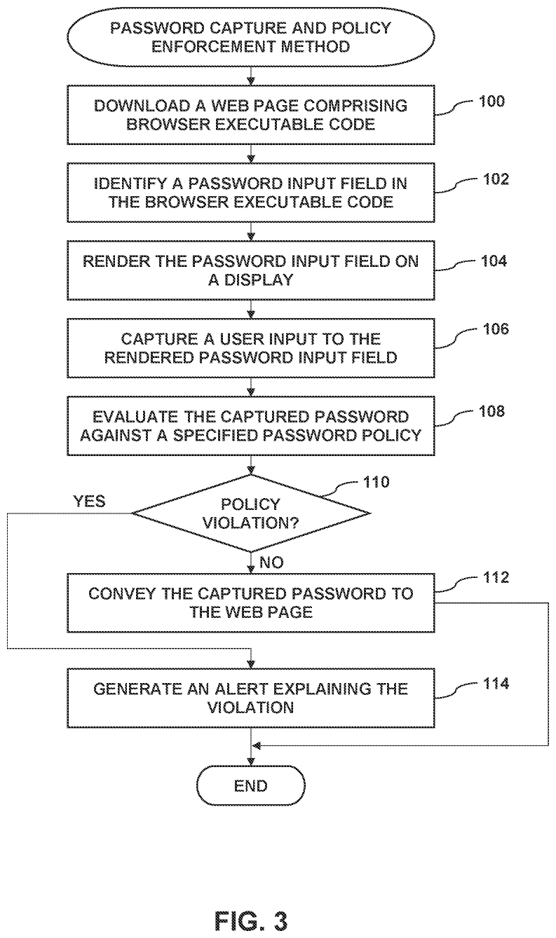

FIG. 3 is a flow diagram that schematically illustrates a method capturing password 86 and evaluating the captured password against one or more password policies 54, in accordance with an embodiment of the present invention. Prior to performing the steps described hereinbelow, processor 60 initiates execution of web browser 70 and browser extension 72.

In step 100, web browser 70 downloads a given web page 32. As described supra, the given web page comprises browser executable code 34 and one or more resources 36. Upon downloading the given web page and executing browser executable code 34, web browser 70 generates a set of DOM elements 76 in DOM 74.

In step 102, browser extension 72 analyzes the downloaded web page and identifies password input field 80 in the downloaded web page. In one identification embodiment, browser extension 72 can identify password input field 80 in browser executable code 34. In a second identification embodiment, upon web browser 70 generating DOM elements 76 in response to executing browser executable code 34, browser extension 72 can identify password input field 80 in the generated DOM elements. As described supra, browser extension 72 can identify password input field 80 (i.e., in browser executable code 34 or DOM elements 76) by detecting a given password tag 82 in a given form tag 84.

In step 104, web browser 70 renders, on display 64, user ID input field 92 and password input field 80.

In step 106, browser extension 72 captures, from user 68 via keyboard 66, a first input to ID input field 92 and a second input to password input field 80. In this step, the first input comprises user ID 94, the second input comprises password 86, and upon receiving the inputs, browser extension 72 can store the entered user ID to captured user ID 96 and store the entered password to captured password 56.

In embodiments herein, capturing user ID 94 and password 86 indicates an attempted login of user 68 to web server 26, and comprises browser extension 72 conveying the entered user ID and the entered password to web browser (i.e., for transmission to web server 26) only upon successfully evaluating (i.e., validating) the entered password, as described hereinbelow.

In step 108, browser extension 72 evaluates captured user ID 96 and captured password 56 against one or more specified password policies 54.

A first example of a given password policy 54 comprises requiring that captured password 56 does not include a specific substring. For example, the specific substring may comprise the name of an organization (i.e., implementing the given password policy). In this example, if the name of the organization is “TEKCO”, and browser extension detects “TEKCO” in captured password 56 comprises “TEKCO”, then the browser extension can flag the captured password as violating the given password policy.

A second example of a given password policy 54 comprises specified criteria that browser extension 72 can apply to captured password 56 so as to classify the captured passwords as either weak or strong. In this example, browser extension can classify captured password 56 as being strong (i.e., complying with the given policy) if the captured password complies with the specified criteria, and classify the captured password as weak (i.e., violating the given policy) if the captured password does not comply with the specified criteria. Examples of the criteria include, but are not limited to, requiring a minimum length for captured password 56, requiring at t least one capitalized letter in the captured password, and requiring that the captured password be “complex” (e.g., a combination of letters, numbers and symbols).

A third example of a given password policy 54 comprises identifying whether or not captured password 56 has been reported as being compromised. In this example, browser extension 72 can convey a tuple comprising captured user ID 94 and captured password 56 to password server 24. Upon password server 24 receiving the tuple, processor 38 can compare the captured user ID and the captured password to pairs of user ID 46 and user password 48 in user password records 42. As described supra, password server 24 can store user password 48 as a hashed value. Therefore, in some embodiments, user password 48 may comprise a hash value, and comparing the captured password to user password 48 may comprise comparing their respective hash values.

If processor 38 detects a given user password record 42 whose (a) user ID 46 matches the received captured user ID, (b) user password 48 matches the received captured password, and (c) compromised flag 52 is set (i.e., indicating the that combination of user ID 46 and user password 48 has been reported as being compromised), then the server processor conveys a message to client computer 22 indicating that the combination of the received user ID 94 and captured password 56 is compromised, thereby violating the given policy.

However, if processor 38 does not identify any user password record 42 matching these conditions (i.e., a, b and c), then the server processor conveys a message to client computer 22 indicating that the combination of the received user ID 94 and captured password 56 is not compromised, thereby complying with the given policy.

A fourth example of a given password policy 54 comprises detecting whether or not captured password 56 has previously been used by user 68. In this example, browser extension 72 can convey, to password server 24, a tuple comprising captured user ID 94, captured password 56, web based application ID 31, and category 33. Upon receiving the conveyed tuple, processor 38 can compare the received tuple to user password records 42 so as to determine whether or not captured password 56 complies with the given password policy.

In a first duplicate password embodiment, if processor 38 detects a given user password record 42 whose (a) user ID 46 matches the received captured user ID, (b) user password 48 matches the received captured password, (c) application ID 48 does not match the web-based application ID 31, then the server processor conveys a message to client computer 22 indicating that user 68 has previously used captured password 56, thereby violating the given policy. However, if processor 38 does not identify any user password record 42 matching these conditions (i.e., a, b and c), then the server processor conveys a message to client computer 22 indicating that user 68 has not previously used captured password 56, thereby complying with the given policy.

In some embodiments, as described supra, password server 24 can store user passwords 48 as hash values or as encrypted hash values. In a first security embodiment for the third and fourth examples of password policies 54, web extension 72 can apply a hash function to captured password 56, store the result of the hash function to secured password 88, and include the secured password (i.e., instead of the captured password) in the tuple that the web extension conveys to the password server.

In a second security embodiment for the third and fourth examples of password policies 54, web extension 72 can apply a hash function to captured password 56, encrypt the result of the hash function using encryption key 90, store the result of the encryption to secured password 88, and include the secured password (i.e., instead of the captured password) in the tuple that the web extension conveys to the password server.

Returning to the flow diagram, in step 110, if in the evaluation(s) in step 108, browser extension 72 determines that that captured password 56 complies with (i.e., does not violate any) the one or more specified password policies, then in step 112, the browser extension can forward the captured password to browser executable code 34, which can convey the captured password to web server 26, and the method ends.

Returning to step 110, if browser extension 72 determines that that captured password 56 violates any of the one or more specified password policies, then in step 114, the browser can generate an alert, and the method ends. In some embodiments, browser extension 72 can generate the alert by presenting, in rendering 78, details of the password policy violation(s). Upon detecting any violations of the one or more specified password policies, browser extension 72 can abort the attempted login to web server 26.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for protecting a client computer, which includes a processor and a display, the method comprising:
analyzing a web page that was downloaded to the client computer;
identifying, by the processor, a password input field in the web page;
capturing, after rendering the password input field to the display, an input to the password input field;
evaluating the captured input against a specified password policy; and
generating an alert upon detecting a violation of the specified password policy.

2. The method according to claim 1, wherein the steps of analyzing, identifying, capturing, evaluating and generating are performed by a browser extension for a web browser configured to download the web page, and to render the password input field.

3. The method according to claim 1, wherein the web page comprises browser executable code, and wherein identifying the password input field comprises identifying the password input field in the browser executable code.

4. The method according to claim 1, wherein the web page comprises browser executable code, and further comprising generating document object model (DOM) elements in response to executing the browser executable code, and wherein identifying the password input field comprises identifying the password input field in one or more of the DOM elements.

5. The method according to claim 1, wherein the captured input comprises a captured password.

6. The method according to claim 5, wherein evaluating the captured input against the specified password policy comprises searching for a specified substring in the captured password, and wherein detecting the violation comprises detecting the specified substring in the captured password.

7. The method according to claim 5, wherein evaluating the captured input against the specified password policy comprises classifying, using a set of criteria, the captured password as either weak or strong, and wherein detecting the violation comprises classifying the captured password as weak.

8. The method according to claim 5, and further comprising rendering a user identifier (ID) input field on the display, capturing an additional input to the user ID field, wherein the captured additional input comprises a captured user ID, and wherein evaluating the captured input comprises conveying, to the password server, a tuple comprising the captured user ID and the captured password.

9. The method according to claim 8, wherein conveying the captured password to the password server comprises applying a hash function to the captured password, and conveying the result of the hash function to the password server.

10. The method according to claim 9, wherein evaluating the captured input against the specified password policy comprises encrypting the result of the hash function, and conveying the encrypted result of the hash function to the password server.

11. The method according to claim 8, wherein detecting the violation of the specified password policy comprises receiving an indication from the password server that the conveyed tuple comprises a compromised password.

12. The method according to claim 8, wherein detecting the violation of the specified password policy comprises receiving an indication from the password server that the conveyed tuple comprises a duplicate password for a user referenced by the user ID.

13. A client computer, comprising:
a display; and
one or more processors configured:
to analyze a web page that was downloaded to the client computer,
to identify a password input field in the web page,
to capture, after rendering the password input field to the display, an input to the password input field,
to evaluate the captured input against a specified password policy, and
to generate an alert upon detecting a violation of the specified password policy.

14. A computer software product for protecting a client computer, which includes a display, the computer software product comprising a non-transitory computer-readable medium, in which program instructions are stored, which instructions, when read by a computer, cause the client computer:
to analyze a web page that was downloaded to the client computer;
to identify a password input field in the web page;
to capture, after rendering the password input field to the display, an input to the password input field;
to evaluate the captured input against a specified password policy; and
to generate an alert upon detecting a violation of the specified password policy.
